(19) United States
(12) Patent Application Publication
(10) Pub. No.: US 2009/0276248 A1
(43) Pub. Date: Nov. 5, 2009

(54) APPARATUS, SYSTEM, AND METHOD FOR FUNDING INSURANCE PREMIUM FINANCING CONTRACTS

(75) Inventors: Scott L. Crowley, Provo, UT (US); Josef C. Heugly, Sandy, UT (US); David F. Gabrielsen, Draper, UT (US)

Correspondence Address: KEN BURRASTON;KIRTON & MCCONKIE, PO BOX 45120, SALT LAKE CITY, UT, 84145-0120, US

(73) Assignee: CAPITAL PREMIUM FINANCING, INC., Draper, UT (US)

(21) Appl. No.: 12/432,506

(22) Filed: Apr. 29, 2009

Related U.S. Application Data
(60) Provisional application No. 61/049,290, filed on Apr. 30, 2008.

(51) Int. Cl. G06Q 40/00

(52) U.S. Cl. 705/4

(57) ABSTRACT

An apparatus, system, method, and computer program product for funding insurance premium financing contracts and loans by a premium financier related to an insurance contract on behalf of an insured entity. Interest can be paid from the premium finance company to an insurance company associated with the insurance contract between a start date and a remittance date on which a premium payment is made on the insurance contract.

This application claims the benefit of Provisional Patent Application Ser. No. 61/049,290, entitled “Apparatus, System and Method for Funding Insurance Premium Financing Contracts,” filed on Apr. 30, 2008, which is hereby incorporated by reference in its entirety.

### BACKGROUND

Many insurance policies, particularly for businesses, are offered by insurance carriers for a period of time (e.g., one year), and the insurance carriers often require that the premium for the entire period be paid up-front as a lump-sum payment. For cash flow management purposes, many businesses prefer to make smaller periodic payments during the period instead of the up-front, lump-sum payment. This has given rise to businesses that specialize in the financing of those premiums. For example, a premium financier typically pays the up-front, lump-sum payment, and the insured then makes smaller periodic payments (e.g., monthly payments) to the premium financier.

When an insurance premium is financed as discussed above, there can be typically five parties involved: the business or individual who purchases the insurance policy (hereinafter the “insured”), the retail insurance agency, the general insurance agency, the insurance carrier, and the premium financier. When an insured is in need of insurance coverage, the insured typically contacts a retail insurance agency. The retail agency works directly with the insured to define the insured's insurance requirements, and then solicits estimates for that insurance from general insurance agencies. Typically, the general agencies have established contractual relationships with the insurance carriers. The general agency solicits a policy proposal, including an estimate, from the insurance carrier, and provides it to the retail agency, which in turn provides the estimate to the business seeking insurance. As discussed above, the insurance carrier typically requires an up-front, lump-sum payment of the insurance premium. Knowing that many businesses and individuals prefer an option of making smaller, periodic payments (e.g., monthly payments) instead of a single up-front, lump-sum payment, the retail agency typically arranges with a premium financier to provide a premium financing option to the insured.

In the event the insured elects to use such a premium financing option, the insured then contracts with the premium financier. The premium financier makes the up-front, lump-sum payment of the premium, and the insured makes smaller periodic payments plus interest to the premium financier. Typically, the premium financier utilizes its own line of credit with a financial institution to make the up-front, lump-sum payment of the insurance premium.

FIG. 1 illustrates a typical insurance transaction. As shown, an insured enters into an agreement to purchase insurance at 102. At 104, the insured enters into an agreement with a premium financier under which the premium financier will pay the insurance premium as an up-front, lump-sum payment. Typically, the contract entered into at 102 requires the insured to pay the insurance premium to the retail agency who sold the insurance policy to the insured. The agreement between the premium financier and the insured entered into at 104 thus typically requires the premium financier to pay the insurance premium to the retail agency. In turn, the retail agency is typically required to pay the premium to the general agency who obtained the insurance policy from an insurance company, and the general agency is required to pay the premium to the insurance company.

As shown in FIG. 1, typically, the retail agency requires payment of the premium at 106, which can typically be prior to the date the insurance policy takes effect at 105, which is commonly referred to as the effective date of the policy. The retail agency then has a time period 112 (e.g., 30 to 60 days) prior to the due date at 108 on which the retail agency must pay the premium to the general agency. As also shown, the general agency may also require payment at 108 of the premium a time period 114 (e.g., 15 to 30 days) prior to the due date at 110 on which the general agency must pay the premium to the insurance carrier. Assuming the premium financier makes the premium payment at 106 from its own line of credit, as soon as the premium financier makes the payment at 106 to the retail agency, the premium financier begins to incur interest charges associated with its line of credit.

As mentioned, the retail agency then has a certain amount of time 112 in which to pass the premium payment on to the general agency at 108. Banking regulations require the retail agency to maintain the insurance premium in a federally insured trust account. Though the interest rates associated with such accounts are low, it has, nevertheless, become an important revenue center for retail agencies. As such, retail agencies tend to hold on to the premium payment for the maximum period 112 possible. When the payment due date to the general agency is reached at 108, commonly referred to as the remittance date, the retail agency passes the premium payment to the general agent. It is important that the payment be paid no later than the remittance date as, in some cases, making the payment later than the remittance date is illegal. General agencies usually also hold the premiums in an interest bearing, federally insured account during the period 114 between receipt of the premium at 108 and payment of the premium to the insurance carrier at 110. Although the period 114 may be shorter than the period 112, the interest earned by the general agency on the premium during period 114 can be important to the general agency. In effect, the premium financier is incurring interest charges so that the retail agency and/or general agency can receive interest on the premium payment.

### BRIEF DESCRIPTION OF THE DRAWINGS

In order that advantages of the invention will be understood, exemplary descriptions will be rendered by reference to specific embodiments that are illustrated in the appended drawings. These drawings depict only typical embodiments of the invention, however, and are not, therefore, to be considered limiting.

FIG. 1 is a schematic block diagram illustrating a typical insurance premium financing transaction;

FIG. 2 is a schematic block diagram illustrating a non-limiting example of a method for funding insurance premium financing contracts according to some embodiments of the invention;

FIG. 3 is a schematic block diagram illustrating a non-limiting example of a computer or computing device on which some or all of a method for funding insurance premium financing contracts according to some embodiments of the invention can be implemented;

FIG. 4 is a schematic diagram illustrating one embodiment of a system for funding insurance premium financing contracts;

FIG. 5 is a schematic block diagram illustrating one embodiment of a user-side apparatus for funding insurance premium financing contracts;

FIG. 6 is a schematic block diagram illustrating one embodiment of a server-side apparatus for funding insurance premium financing contracts;

FIG. 7 is a schematic flow chart diagram illustrating one embodiment of a method of funding insurance premium financing contracts.

### DETAILED DESCRIPTION

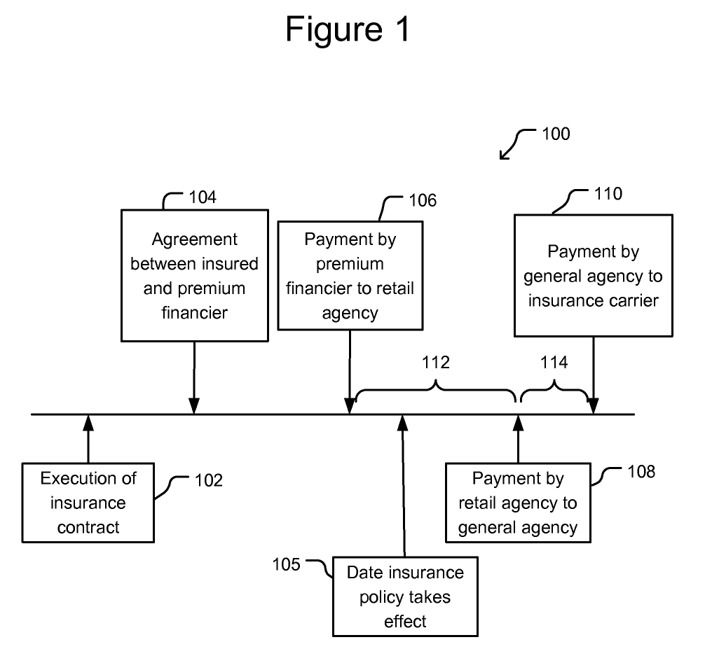

As introduced above in FIG. 1, in typical insurance transactions, the premium financier borrows against its line of credit to pay the premium to the retail agency. The retail agency and general agency typically hold this premium payment, earning interest, for some time before the payment is forwarded to the insurance carrier.

In most instances, the amount of interest the premium financier must pay on its line of credit is well above the amount of interest either the retail or general agent is able to earn on the insurance premium while it is in the retail or general agent's bank account during period 112 or period 114. The difference between two related interest rates is commonly referred to as the spread. This spread indicates inefficiency in the currently employed system shown in FIG. 1. Some embodiments of the present invention can address that inefficiency, reducing the spread and creating a more efficient system for the parties involved.

Some embodiments of the invention comprise a system, method and apparatus for funding insurance premium financing contracts. Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

In general, computer-executable instructions can cause a processor (e.g. as described further below) to perform a particular function or group of functions and are examples of computer readable program code for implementing processes and methods disclosed herein. Furthermore, a particular sequence of the computer-executable instructions provides an example of corresponding acts that can be used to implement the operations of such processes and methods. The computer-executable instructions can be permanently stored in the instruction memory accessible to the process, or can be temporarily stored in the instruction memory and loaded into the instruction memory from a computer-readable medium, for example, via an interface to the instruction memory. The computer-executable instructions can include data structures, objects, programs, routines, or other program modules that can be accessed by the processor. For example, computer executable instructions can include operating system instructions used to establish communication or enable loading of programs, such as during start-up of the computer system.

Examples of computer-readable media include random-access memory (RAM), read-only memory (ROM), programmable read-only memory (PROM), erasable programmable read-only memory (EPROM), electrically-erasable programmable read-only memory (EEPROM) (including for example, flash memory), compact disk read-only memory (CD-ROM), digital video disk (DVD), magnetic media, or any other devices or components that are capable of providing data or executable instructions that can be accessed by a processor.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

In some embodiments of the present invention, the retail agency, and in some circumstances the general agency, allow the premium financier to delay payment of the insurance premium (e.g., until the remittance date of the agency involved). In exchange, the premium financier agrees to pay the agency involved interest on the insurance premium as if the agency involved had deposited the insurance premium into an interest bearing account. The period of time interest is paid can begin on the effective date and end on the remittance date, when the insurance premium financier's contract funding system automatically pays the premium to the agency involved from either its bank account or line of credit account, or use other periods of time. The amount of interest the premium financier pays the agency involved can be higher than what the agency would be able to earn were the insurance premium in its federally insured trust account, yet the interest paid can be lower than the interest the premium financier would be paying to the provider of the premium financier's line of credit after making the insurance premium payment. Such a system can provide a benefit to the premium financier and the agency involved, and give the agency involved additional incentive to use a premium financier employing the system.

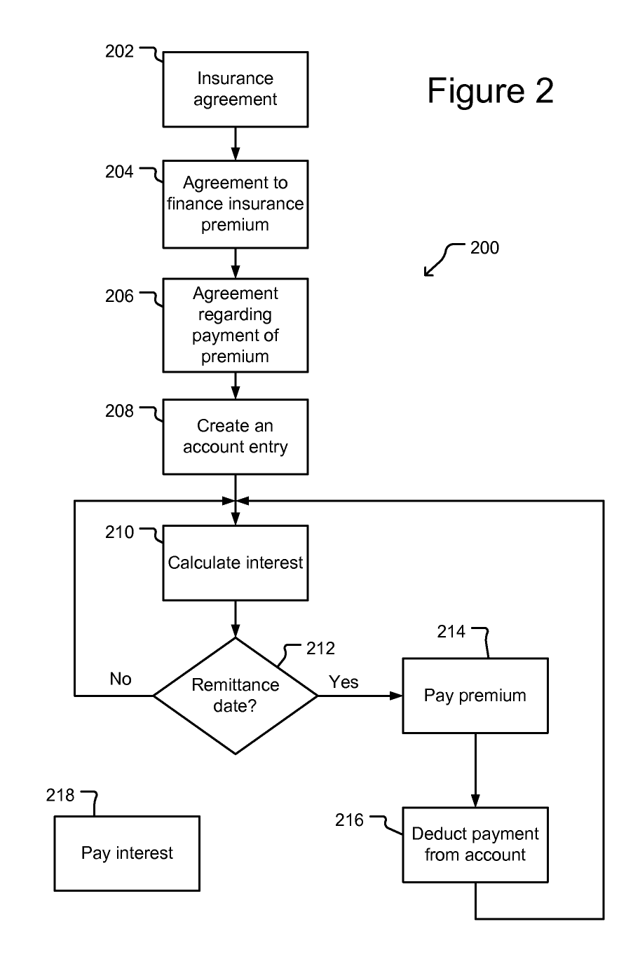

FIG. 2 illustrates an exemplary process showing a non-limiting example of the foregoing according to some embodiments of the invention. As shown, an insured enters into a contract for an insurance policy at 202. The insured can be any entity including without limitation a business or a person. The insurance policy can be any type of insurance. Element 202 in FIG. 2 can correspond to 102 in FIG. 1. At 204, the insured enters into an agreement with a premium financier under which the premium financier agrees to pay the insurance premium on the insurance policy, and the insured agrees to make periodic payments to the premium financier. Element 204 in FIG. 2 can correspond to 104 in FIG. 1. The agreement at 204 can require that the premium financier make the payment to the insurance agency that sold the insurance policy to the insured.

At 206, the premium financier and the insurance agency to whom the premium financier is to make the insurance premium can enter into an agreement under which the insurance agency agrees to accept payment on a particular date (herein referred to as the remittance date of the agency) and the premium financier agrees to pay interest to the insurance agency on the amount of the premium payment for a time period prior to the remittance. To ensure the premium payment is made prior to, or on, the remittance date, the contract funding system may automatically transfer the necessary funds from one of the premium financier's accounts or line of credit to the insurance agency's account. The start date of the time period can be as agreed on by the premium financier and the insurance agency. For example, the start date can be the effective date of the insurance policy (e.g., 106 in FIG. 1) or a date prior to the effective date (e.g., 105 in FIG. 1). Referring to FIG. 1, if the insurance agency is a retail agency, this agreement can typically involve the retail agency agreeing to accept payment from the premium financier on, or one, or a few days prior to the date at 108 in FIG. 1 on which the retail agency must pay the premium to the general agency. The premium financier may enter the agreed date into the system, and the payment may then be made automatically on the agreed date through an electronic funds transfer. The start date can be the date the retail agency would typically have required payment from the premium financier, which can be 106 in FIG. 1. As an alternative, the agreement at 206 can be that the premium financier pays the premium not to the insurance agency but to the entity to whom the insurance agency is required to pay the insurance premium. For example, still referring to FIG. 1, the agreement at 206 between the premium financier and the retail agency can be that the premium financier pays the premium directly to the general agency at 108. In such a case, 206 in FIG. 2 can optionally also include an agreement between the premium financier and the general agency in which the general agency agrees to accept payment from the premium financier on or one or a few days prior to its remittance date (e.g., the date on which the general agency must pay the premium to the insurance carrier at 110 in FIG. 1). In this example, the start date of the period during which the premium financier will pay interest to the general agency can be the date the general agency would typically have required payment from the retail agency, which can be 108 in FIG. 1. Of course, the general agency can agree that the premium financier pays the premium directly to the insurance carrier—rather than the general agency—at 110 in FIG. 1.

Under the agreement entered into at 206, the insurance agency (e.g., the retail agency and/or the general agency) can agree to accept payment of the insurance premium at a later date than the insurance agency typically requires in return for payment of interest by the premium financier on the amount of the insurance premium. Summarizing and again referring to FIG. 1, a retail agency can agree to reduce the period 112 to zero, one, or a few days, in return for the premium financier paying interest to the retail agency on the amount of the insurance premium during the period 112. As discussed above, the agreement can be extended to a general agency, who can agree to reduce the period 114 in FIG. 1 to zero, one, or a few days in return for the premium financier paying interest to the general agency on the amount of the insurance premium during the period 114.

The interest paid can be greater than the interest the insurance agency could earn by depositing the insurance premium into a federally insured bank account during the period 112 in FIG. 1 (in the case of a retail agency) or the period 114 in FIG. 1 (in the case of a general agency). Consequently, the insurance agency can benefit from the agreement at 206 of FIG. 2. The interest paid can, at the same time, be less than the interest the premium financier would pay during the period 112 and/or the period 114 in FIG. 1 on a line of credit for borrowing the amount of the premium. The agreement at 206 thus can benefit all of the parties to the agreement and can make efficient use of the insurance premium funds.

Referring again to FIG. 2, at 208, the premium financier creates an account entry for the agreement with the insurance agency entered into at 206. The account entry can include, among other information, an identification of the insurance agency, an identification of the entity to whom premium is to be paid (which can be the insurance agency), the amount of the insurance premium, the start date of the interest period, the remittance date (which can be the end date of the interest period), the account information of the account to which the payment should be automatically made on the agreed date, and the interest rate or formula to be used to determine accrued interest during the interest period. As mentioned, the start date can be the date on which the premium financier will begin to pay interest to the insurance agency on the amount of the premium. The remittance date can be the date the premium financier will pay the premium to the insurance agency, and also the date on which the premium financier will stop paying interest to the insurance agency on the amount of the premium.

The premium financier can enter into multiple agreements with multiple insurance agencies. The premium financier can likewise enter into multiple agreements with the same insurance agency. Elements 202, 204, 206, and 208 of the process of FIG. 2 can be repeated for each such agreement. Consequently, multiple account entries can be created at 208, resulting in multiple account entries with respect to multiple insurance agencies, and there can be multiple account entries for the same insurance agency.

Still referring to FIG. 2, accumulated interest can be calculated at 210 for one or more of the entries created at 208. The amount of the interest and the manner in which interest is calculated can be any amount and manner agreed to by the premium financier and the insurance agency. For example, the interest can be simple interest or compound interest. Moreover, the interest can be on a principal amount equal to the amount of the premium or on another principal amount. For example, if the insurance agency has entered into multiple agreements (e.g., at 206 of FIG. 2) and multiple account entries have been made at 208 for those agreements, the principal on which interest is calculated at 210 can be a total of all of the insurance premium amounts from those account entries. Element 210 can include calculating interest for each of the account entries created at 208, which as mentioned, can include accounts for different insurance agencies. As also mentioned, multiple account entries can be made at 208 for the same insurance agency, and the calculation of interest at 210 can be on a sum total of all of the premium amounts in those account entries for the insurance agency, or interest can be calculated at 210 for each individual account entry for a particular agency. It should be noted that the premium amount in an account entry need not represent the actual transfer of funds or money to the premium financier. Rather, the premium amount can represent the amount of the premium the premium financier will pay on the remittance date, which can be, for example, 108 or 110 in FIG. 1. As discussed above, the payment of interest during the interest period can be in return for reduction of period 112 or period 114 in FIG. 1.

At 212, it is determined whether the remittance date for any of the account entries created at 208 is due. As mentioned above, account entries created at 208 can include the due date for payment of the insurance premium (the remittance date) associated with the entry. Element 212 can thus be performed by examining the account entries created at 208. If it is determined at 212 that a remittance date has not been reached, the process can branch such that interest is again calculated at 210. If it is determined at 212 that a remittance date for an entry created at 208 has been reached, the premium payment that is due is automatically paid at 214. As mentioned above, account entries created at 208 can include the amount of the insurance premium and the entity to whom the payment is to be made. At 216, the corresponding account entry is deleted or annotated to note that interest is no longer to be paid on the insurance premium for that entry. The process of FIG. 2 can then branch such that interest is again calculated at 210.

Whether the process of FIG. 2 branches from element 212 or element 216 to repeat calculating interest at 210, the process of FIG. 2 can be configured so that calculating interest at 210 is repeated periodically (e.g., every business day, every week, every month, etc.) or on some other schedule. Each interest calculation made during a repetition of 210 for a particular account entry can be added to the previous calculation of interest made for that entry so that a total amount of interest accumulated for a particular account entry is maintained.

As shown in FIG. 2, the process of FIG. 2 can also include making interest payments of such calculated interest to the insurance agencies. Such payments of accumulated interest can be made in accordance with an agreement with each insurance agency. For example, the interest payment at 218 can be made after payment of the premium at 214. As another example, the interest payment at 218 can be made periodically on a pre-agreed schedule.

Although not shown in FIG. 2, the process can include additional steps or actions. For example, the process of FIG. 2 can include creating periodic statements of account entries and/or accumulated interest for each account entry created at 208 or for each insurance agency.

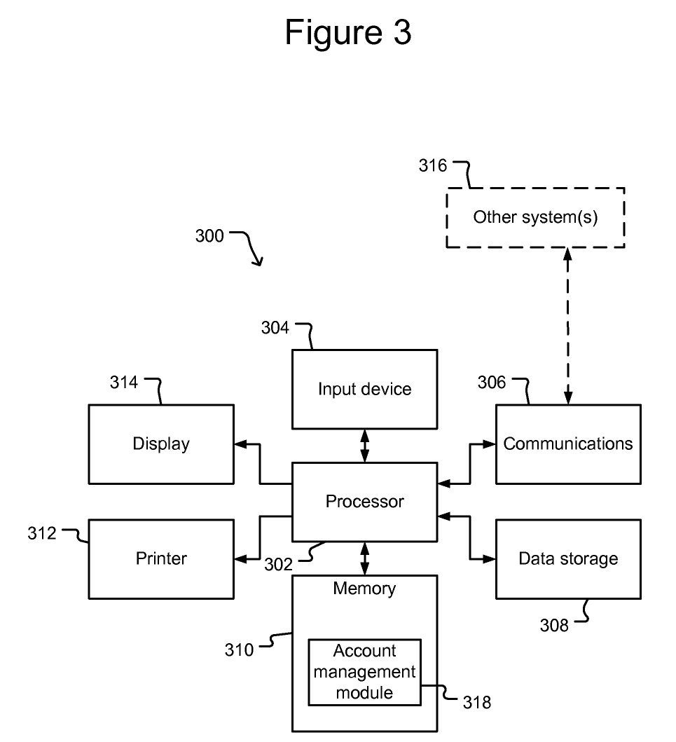

The process shown in FIG. 2 can be implemented entirely manually by a person or persons. Alternatively, at least some or all of elements 208-218 can be implemented in one or more computers or other computing devices. FIG. 3 illustrates a non-limiting example of a computer or computing system 300 on which some or all of elements 208-218 can be implemented. For example, some or all of elements 208-218 can be embodied in software (e.g., software, firmware, microcode, etc.) stored in memory 310 and configured as instructions to be executed on processor 302. In the example shown in FIG. 3, elements 208-218 of FIG. 2 are implemented in software as an account management module 318, which can be stored in memory 310. Account management module 318 can be implemented as more than one module.

Processor 302 can be any kind of microprocessor, microcontroller, or other type of processor, computer, computer system, or computing device that operates in accordance with instructions in the form of software, microcode, firmware, or other machine readable code stored in memory 310. Memory 310 can be any type of semiconductor, magnetic, or optical memory or other storage device in which digital data can be stored. As shown, system 300 can include a printer 312, a display 314, a communications module 306, data storage 308, and an input device 304. Printer 312 can be any type of printing device, and display 314 can be any type of computer display device readable by a human. Data storage 308 can include any type of digital storage device or devices including magnetic and/or optical memory device(s) and/or semiconductor memory device(s). Input device 304 can include input device(s) such as a keyboard, a mouse, an optical input device, etc. Communications module 306 can be any device for communicating with another computer or electronic systems (e.g., other system(s)) in FIG. 3. For example, communications module 306 can be a modem or a network interface. Account management module 318 can comprise software, firmware, microcode, or other instructions readable by or that can be made readable by processor 302. Account management module 318 can be compiled or uncompiled in memory 310.

As mentioned, one, some, or all of elements 208-218 can be implemented by account management module 318. Thus, all or part of one or more of elements 208-218, for example, as described above with respect to FIG. 2 can be implemented as software stored in memory 310 and executed by processor 302 in system 300 of FIG. 3.

For example, at 208 of FIG. 2, processor 302, executing account manager module 318 (hereinafter references to processor 302 or account manager module 318 performing a task refer to processor 302 executing account manager module 318), can accept the information regarding a new account entry as described above with respect to 208 of FIG. 2. Processor 302 can prompt a human user to input the information. For example, processor 302 can display prompts and input fields on display 314. Once the information is entered, processor 302 can store the information in data storage 308. For example, processor 302 can create a data record in data storage 308 that stores the information for an account entry described above with respect to 208 of FIG. 2. Such a record can include, as discussed above, the identification of the insurance agency who is a party to an agreement entered into at 206, the identification of the entity to whom the insurance premium is to be paid, the amount of the insurance premium, the start date of the interest period, the remittance date for payment of the premium, the account information of the account to which the payment should be automatically made by the computer system 300 on the remittance date, and the interest rate or formula to be used to calculate accrued interest during the interest period as generally described above with respect to 208 of FIG. 2. As previously noted, many agreements can be entered into at 206, and many corresponding account entries can be created at 208 by processor 302 and stored in data storage 308. Execution of 208 of FIG. 2 by processor 302 can thus include the acquisition and storage of information regarding one or more agreements entered into at 206, which can relate to agreements entered into at 204 and 202 as generally described above with respect to 206, 204, and 202 of FIG. 2.

Processor 302 can perform 210, generally as discussed above with respect to FIG. 2, by calculating interest accrued on a premium amount in an account entry stored in data storage 308. Processor 302 can do so for one or more (including all) of the account entry records stored in data storage 308. Processor 302 can calculate interest for a particular entry in any of the ways described above with respect to 210 of FIG. 2. As mentioned, a record stored in data storage 308 for a particular account entry can include the amount of the premium and an interest rate or interest formula, and processor 302 can calculate accrued interest at 210 for the account entry by reading the corresponding record from data storage 308 and applying the interest rate or formula to the premium amount. Processor 302 can store the amount of the accrued interest in the record for the account entry in data storage 308.

Processor 302 can perform 212 generally as discussed above with respect to FIG. 2. For example, processor 302 can determine whether the remittance date for any of the account entries stored as records in data storage 308 has been reached by comparing the current date to the stored remittance date in the record. Processor 302 can do so for one, some, or all of the records of account entries in data storage 308. As discussed above, with respect to FIG. 2, processor 302 can repeat 210 if a no determination is made at 212. As also discussed above, processor 302 can be configure (by account manager module 318) to periodically repeat 210 (e.g., daily, weekly, etc. or on another specified schedule).

As generally also discussed above, if a yes is determined at 212, processor 302 can branch to 214 of FIG. 2. Processor 302 can execute 214 by taking any of many possible actions. For example, processor 302 can, at 214, display on display 314 an indication readable by a human user that the premium whose remittance date was identified at 212 is due and must be paid. The displayed information can include the remittance date, the amount of the premium to be paid, and the entity to whom the premium is to be paid. Such an indication and information can alternatively or additionally be printed by printer 312. As another possibility, such an indication and information can be provided through communications module 306 to other system(s) 316. This can be done by email or communication to other system(s) 316, which can store, print, display, or further process the indication and information. As yet other exemplary possibility of an action processor 302 can take as part of executing 214, processor 302 can cause printer 312 to print a check or other instrument for paying the premium, or processor 302 can send signals at 214 through communications module 306 to other system(s) 316 that result in a transfer of funds from the premium financier's bank or other financial account to a similar account owned by the party (who can be identified in the account information stored in data storage 308) to whom the premium is to be paid.

Processor 302 can perform 216 of FIG. 2 by deducting the amount of the premium paid at 214 from the record stored in data storage 308 for the account entry whose premium amount was paid at 214. Processor 302 can do so by modifying the corresponding account entry record stored in data storage 308. Interest is not thereafter accrued on the amount of the deducted premium at future repetitions of 210.

Generally in accordance with the discussion above of 218 of FIG. 2, processor 302 can pay interest at 218 of FIG. 2. Processor 302 can do so periodically or at a specified date (e.g., a remittance date identified at 212). At 218, processor 302 can take any of many possible actions. For example, processor 302 can, at 218, display on display 314 an indication and related information readable by a human user that an interest payment is to be made. The displayed indication and information can include the amount of the interest to be paid and the entity to whom the premium is to be paid. Such an indication and information can alternatively or additionally be printed by printer 312. As another possibility, such an indication and information can be provided through communications module 306 to other system(s) 316. This can be done by email or communication to other system(s) 316, which can store, print, display, or further process the indication and information. As yet other exemplary possibility of an action processor 302 can take as part of executing 218, processor 302 can cause printer 312 to print a check or other instrument for paying the interest, or processor 302 can send signals at 218 through communications module 306 to other system(s) 316 that results in a transfer of funds from the premium financier's bank or other financial account to a similar account owned by the party to whom the interest is to be paid. The amount of the accrued interest and the party to whom the interest is to be paid can be stored in data storage 308, for example, in a corresponding record of an account entry.

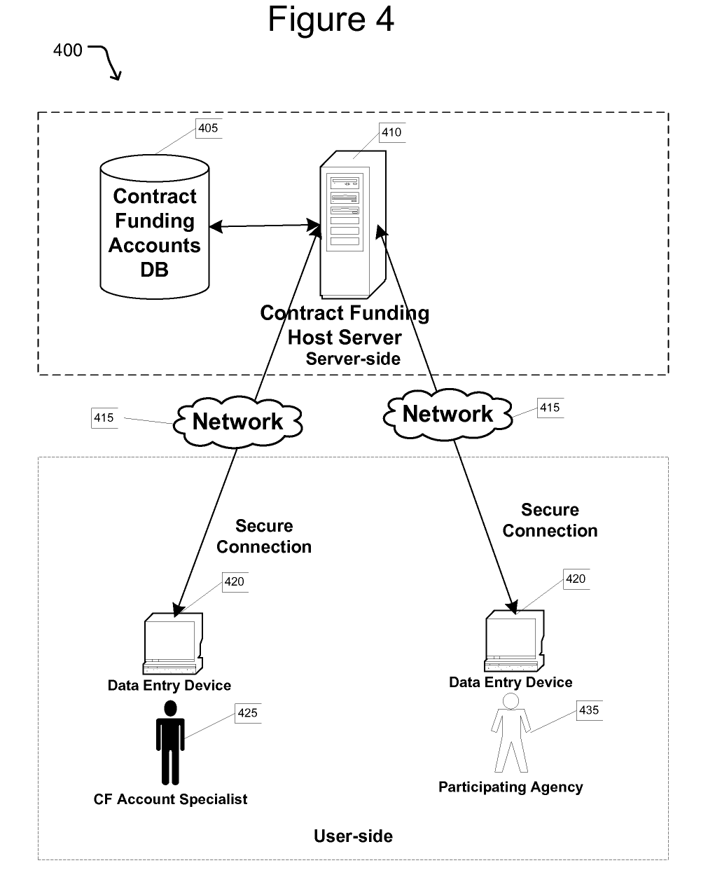

FIGS. 4-7 illustrate additional exemplary embodiments and configurations of a system like system 300 that can be used to implement a process for funding insurance premiums generally in accordance with one or more of the principles discussed above.

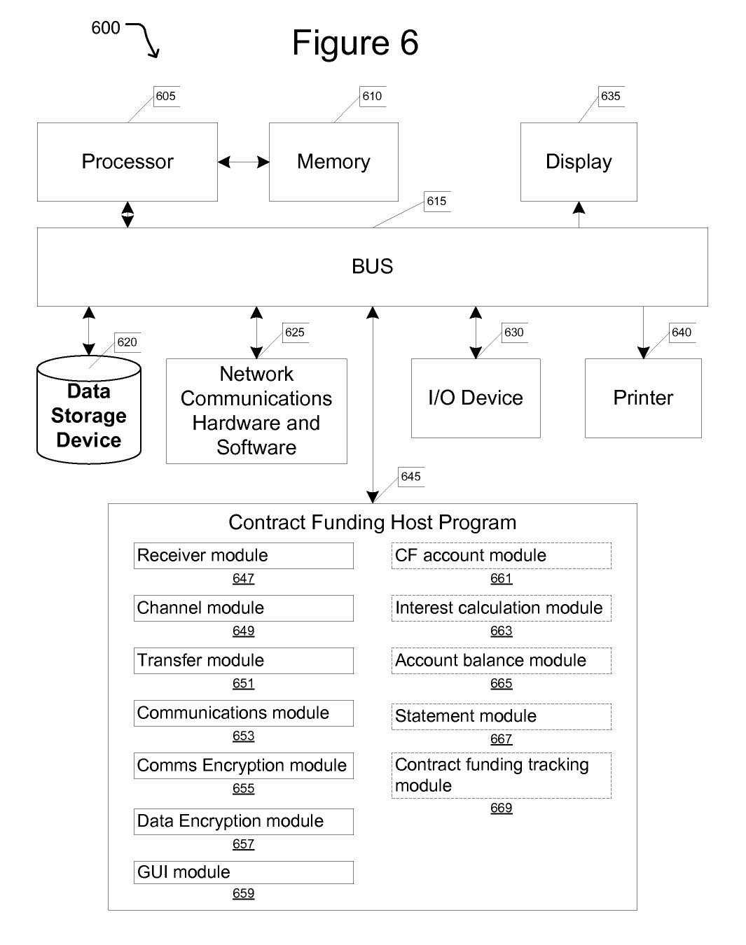

FIG. 4 is a schematic diagram illustrating one embodiment of a system 400 for funding insurance premium financing contracts in accordance with the present invention. As depicted, a Contract Funding (CF) Host Server 410 communicates with a Contract Funding Accounts Database 405. The CF Account Specialist 425 uses a remote communication device 420 to communicate with the Contract Funding Host Server 410 through a Remote Contact Network 415. In one embodiment, the Participating Agency 435 also uses a remote communication device 420 to communicate with the Contract Funding Host Server 410 through a Remote Contact Network 415. The CF Account Specialist 425 can be a representative (e.g., an employee) of the premium financier and the Participating Agency 435 can likewise be a representative (e.g., an employee) of the insurance agency whose agreement regarding insurance premium financing (like the agreement at 104 in FIG. 1 or 206 in FIG. 2) is the subject matter of the insurance contracting funding described in FIGS. 4-7. In the depicted embodiment, the Contract Funding Host Server 410 can contain the apparatus depicted in FIG. 6, and can run the Contract Funding Host Program 645.

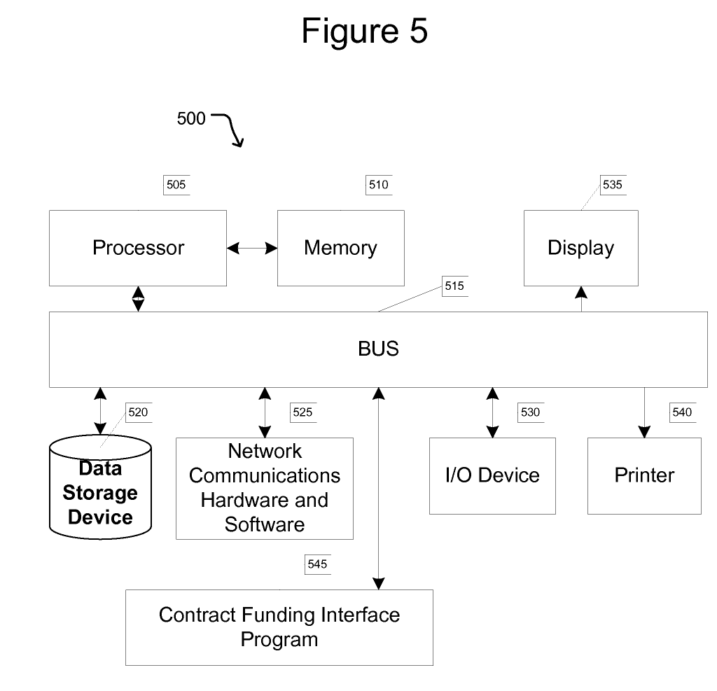

FIG. 5 is a schematic block diagram illustrating one embodiment of user-side apparatus 500 (which can be a non-limiting example of the remote communication device 420 of FIG. 4) for funding insurance premium financing contracts. As depicted, the apparatus users (CF Account Specialist 425 and Participating Agency 435) can employ a computer-like device typically using a Processor 505 (e.g., a Central Processing Unit), a Memory 510 (e.g., Random Access Memory), an Interface Bus 515, a Data Storage Device 520, Network Communications Hardware and/or Software 525, Input/Output Device 530, Display Device 535, and Printer 540. The computer device can runs a program of instructions, such as the Contract Funding Interface Program 545, which enables the users to interface with the Contract Funding Host Server 410.

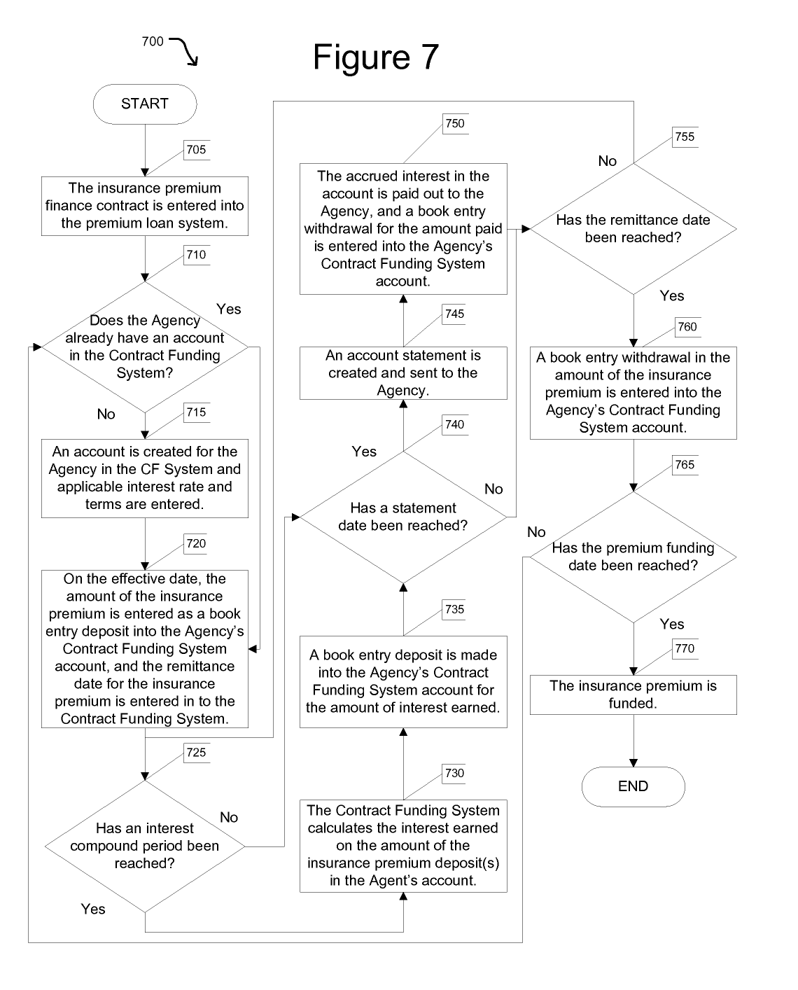

FIG. 6 is a schematic block diagram illustrating one embodiment of a server-side apparatus 600 (which can be a non-limiting example of the contract funding server 410) for funding insurance premium financing contracts. As depicted, the server side apparatus 600 includes a computer like device typically using a Processor 605 (e.g., a Central Processing Unit), a Memory 610 (e.g., Random Access Memory 610), an Interface Bus 615, a Data Storage Device 620, Network communications hardware and/or software 625, Input/Output Device 630, Display Device 635, and Printer 640. The computer device runs a program of instructions, the Contract Funding Host Program 645, which carry out the functions of the funding insurance premium financing contracts system, such as those depicted in elements 208-218 of FIG. 2, and elements 705-770 of FIG. 7.

In the depicted embodiment, the Contract Funding Host Program 645 contains a Receiver module 647, a Channel module 649, a Transfer module 651, a Communications module 653, a Communications Encryption module 655, a Data Encryption module 657, a Graphical User Interface (GUI) module 659, a CF account module 661, and Interest calculation module 663, an Account balance module 665, a Statement module 667, and a Contract funding tracking module 669. The Receiver module 647 receives inputs and instructions from outside the program. The Channel module 649 establishes a communications channel with other parts of the apparatus 600. The Transfer module 651 controls the transfer of data from one part of the apparatus 600 to another part of the apparatus 600, as well as from one part of the system 400 to another part of the system 400. The Communications module 653 controls communications to and from the CF Account Specialist 425. The Comms Encryption module 655 facilitates the secure transmission of data to and from the CF Account Specialist 425. The Data Encryption module 659 contains the set of instructions needed for encrypting personal attribute elements or information elements on the Contract Funding Accounts Database 405. The CF account module 661 contains the set of instructions for controlling access to the appropriate user accounts, and, in one embodiment, also contains instructions for interfacing with, and organizing, the data contained in the Contract Funding Accounts Database 405. In one embodiment, the Graphical User Interface (GUI) module 659 provides a user interface to the system for the CF Account Specialist 425.

In the depicted embodiment, the CF Account Specialist 425 gains access to the Contract Funding Host Program by establishing a communication link with the system using the Receiver Module 647, the Channel Module, 649, the Transfer module 651, the Graphical User Interface (GUI) module 659, and then authenticating with electronic credentials using the Comms Encryption module 655, the CF account module 661, and the Contract Funding Accounts Database 405. In one embodiment, the CF Account Specialist 425 creates a new Agency contract funding account, and makes modifications (such as terms, deposits and withdrawal transactions) to existing Agency contract funding accounts, using the Receiver module 647, the Channel module 649, the Transfer module 651, the Graphical User Interface (GUI) module 659, the Data Encryption module 657, and the Contract Funding Accounts Database 405. The Contract Funding Host Program 645 calculates the interest for Agency accounts in the Contract Funding Accounts Database 405 using the Receiver module 647, the Channel module 649, the Transfer module 651, the Data Encryption module 657, the Interest calculation module 663, and the Contract Funding Accounts Database 405. The Contract Funding Host Program 645 updates Agency account balances for Agency accounts in the Contract Funding Accounts Database 405 using the Receiver module 647, the Channel module 649, the Transfer module 651, the Data Encryption module 657, the Account balance module 665, and the Contract Funding Accounts Database 405.

The Contract Funding Host Program 645 creates statements for Agency accounts in the Contract Funding Accounts Database 405 using the Receiver module 647, the Channel module 649, the Transfer module 651, the Data Encryption module 657, the Statement module 667, and the Contract Funding Accounts Database 405. In one embodiment, the statements are sent to the CF account specialist 425 using the Communications module 653, and the Communications Encryption module 655. In another embodiment the statement may be sent to the Participating Agency 435 corresponding to the Contract Funding Account in the Contract Funding Accounts Database 405 using the Communications module 653, and the Communications Encryption module 655. An electronic copy may also be viewed by the Participating Agency 435 of CF Account Specialist 425. The modules 647-669 in FIG. 6 are exemplary only, and Contract Funding Host Program can have fewer or more of the modules and can have different modules.

The Contract Funding Host Program 645 tracks the remittance dates for contracts using the Contract funding tracking module 669. In one embodiment, the Contract Funding Host Program 645 makes the required payment on the remittance date through an automated transfer of funds from the premium financier's account to the Participating Agency's account using the Receiver module 647, the Channel module 649, the Transfer module 651, the Data Encryption module 657, the Contract funding tracking module 669, and the Contract Funding Accounts Database 405.

In one embodiment, the Contract Funding System 400 and its associated apparatuses 500 and 600, exist separate from the company's premium loan system. In another embodiment, the Contract Funding System 400 and its associated apparatuses 500 and 600, exists as a module of the company's premium loan system.

FIG. 7 is a schematic flow chart diagram illustrating one embodiment of a method 700 for funding insurance premium financing contracts. Throughout this description reference is made to the Contract Funding System, or CF System. For the purposes of this description, such references will refer to the Contract Funding System and its associated apparatuses. Prior to the beginning of the process a Participating Agency 435 (Agency), or the customer of the Agency 435, chooses to finance an insurance premium with the company, and the Agency 435 chooses to use the Contract Funding System, for example, as in 202 and/or 204 and FIG. 6 of FIG. 2.

In step 705, the insurance premium finance contract (e.g., as entered into at 206 of FIG. 2) is entered into the company's premium loan system. In step 710, the CF Account Specialist 425 determines whether the Agency 435 already has an account in the CF System or not. If the Agency 435 does not, then the CF Account Specialist 425 creates an account 715 for the Agency 435, and enters the applicable interest rate and terms associated with the Agency 435. In step 720, on the date the Agency 435 normally would have required payment of the insurance premium (e.g., the effective date of the insurance policy at 105 in FIG. 1 or prior to the effective as 106 in FIG. 1), the amount of the insurance premium that will eventually be funded is entered into the CF System as a book entry deposit into the Agency's 435 account. At that time, additional data, such as but not limited to, the date the Agency 435 will need to make payment for the insurance premium (the remittance date), the final required funding date of the insurance premium, and who the premium payment must be sent to, is also entered into the CF System. In step 730, the CF System calculates the amount of interest the Agency's 435 account has earned. In one embodiment the calculation may be based on the average daily balance of the Agency's 435 account. In another embodiment, the calculation may be based on the current amount of the insurance premium deposit(s) in the Agency's 435 account. Other embodiments may calculate the amount of interest earned in yet a distinct manner from the embodiment presented herein.

In step 735 the amount of interest earned is entered into the Agency's 435 CF System account as a book entry deposit. In step 740, if a statement date has been reached, then in step 745 the CF System creates a statement and sends it to the Agency 435. As indicated in step 750, when the statement is sent to the Agency 435, the interest that has accrued in the Agency's 435 CF System account since the last statement date is paid out to the Agency 435 and a book entry withdrawal for the payment is entered into Agency's 435 CF System account. The payment may be made to the Agency 435 in any number of ways, such as, but not limited to, an ACH payment, a check, or a transfer of funds into a different account outside of the CF System.

In step 755, if the remittance date has been reached for the insurance premium, then in step 760 a book entry withdrawal in the amount of the funded insurance premium is entered into the Agency's 435 CF System account. In step 765, if the contract funding date has been reached, then in step 770 the insurance premium is funded by the system making an automated payment for the amount of the insurance premium to the appropriate party, and this concludes the Contract Funding System process for this particular insurance premium. If in step 765 the contract funding date has not been reached, for example because Agency 435 was a retail agent, and the general agent that Agency 435 remits payment to for the insurance premium is also participating in the premium financier's Contract Funding program, then the process begins anew with the general agent now the Agency 435.

The present invention may be embodied in other specific forms without departing from its spirit or essential characteristics. The described embodiments are to be considered in all respects only as illustrative and not restrictive.

1. A system for funding insurance premium financing contracts and loans, wherein an insurance contract is executed on behalf of an insured entity and a financing agreement is executed between said insured entity and a premium financier wherein said insured entity agrees to make periodic payments to said premium financier and said premium financier agrees to fund said insurance contract, said system comprising:
a contract funding host server comprising a data communications interface, and a network interface;
a contract funding accounts database in communication with the contract funding host server through the data communications interface, said contract funding accounts database comprising a plurality of account entries, one of said account entities comprising information describing a premium payment associated with said insurance contract, an effective date of said insurance contract, a remittance date of said insurance contract, and an insurance company associated with said insurance contract;
a data entry device in communication with said contract funding host server through said network interface, said data entry device enabling a user to enter information into said accounts database;
wherein said contract funding host server calculates an interest amount on said premium payment for a period extending between a start date and said remittance date, wherein said start date is on or before said effective date; and
wherein said contract funding host server initiates a premium payment from said premium financier to an insurance company responsible for said insurance contract on said remittance date.

2. The system of claim 1 wherein said insurance company is a company type selected from the group of company types consisting of: a retail insurance agency, a general insurance agency, and an insurance carrier.

3. The system of claim 1, wherein said contract funding server calculates a plurality of interest payments corresponding to a plurality of different insurance contracts each having corresponding first dates and remittance dates stored in corresponding ones of said plurality of account entries.

4. The system of claim 1, wherein said system comprises means for providing a secure communications interface between said user of said data entry device and said contract funding accounts database.

5. The system of claim 1, further comprising a second data entry device in communication with said contract funding host server, said second data entry device enabling an insurance company to view information in said accounts database.

6. The system of claim 1, wherein said contract funding host server initiates payment of said interest amount from said premium financier to said insurance company.

7. The system of claim 1, wherein said contract funding host server initiates payment of portions of said interest amount from said premium financier to a plurality of insurance companies associated with said insurance contract.

8. An apparatus for funding insurance premium financing contracts and loans, wherein an insurance contract is executed on behalf of an insured entity and a financing agreement is executed between said insured entity and a premium financier wherein said insured entity agrees to make periodic payments to said premium financier and said premium financier agrees to fund said insurance contract, said apparatus comprising:
means for initiating a premium payment from said premium financier to an insurance company responsible for said insurance contract on a remittance date subsequent to an effective date of said insurance contract;
means for determining an interest payment from said premium financier to said insurance company corresponding to a computed interest on said premium payment for a period extending between a start date and said remittance date; and
wherein said start date is on or before said effective date.

9. The apparatus of claim 8 wherein said insurance company is a company type selected from the group of company types consisting of: a retail insurance agency, a general insurance agency, and an insurance carrier.

10. The apparatus of claim 8 further comprising means for initiating a payment of said interest payment from said premium financier to said insurance company.

11. The apparatus of claim 8, wherein said means for determining an interest payment comprises means for determining a plurality of interest payments corresponding to a plurality of different insurance contracts each having corresponding first dates and remittance dates.

12. A computer program product, comprising a computer usable medium having a computer readable program code embodied therein, said computer readable program code being readable by a computer to cause said computer to execute a process for funding insurance premium financing contracts and loans related to an insurance contract, wherein a financing agreement is associated with said insurance contract wherein an insured entity agrees to make periodic payments to a premium financier and said premium financier agrees to fund said insurance contract, the process comprising:
providing a system, wherein said system comprises distinct software modules, and wherein said distinct software modules comprise a contract funding account module, an interest calculation module, an account balance module, and a contract funding tracking module;
accessing an account entry to enter information into said account entry, said information comprising a premium payment associated with said insurance contract, an effective date of said insurance contract, a remittance date of said insurance contract, and wherein said accessing is performed by said contract funding account module in response to input to said computer indicating said financing agreement has been executed;
computing interest on said premium payment for a period extending between a start date and said remittance date, wherein said start date is on or before said effective date, wherein said computing is performed by said interest calculation module;
updating a balance in said account entry to account for said interest, and wherein said updating is performed by said account balance module in response to said interest calculation module; and
initiating a premium payment from said premium financier to an insurance company responsible for said insurance contract on said remittance date, and wherein said initiating is performed by said contract funding tracking module.

13. The system of claim 12, wherein said insurance company is a company type selected from the group of company types consisting of: a retail insurance agency, a general insurance agency, and an insurance carrier.

14. A method for funding insurance premium financing contracts and loans by a premium financier, wherein an insurance contract is executed on behalf of an insured entity, said insurance contract having an effective date, said method comprising:
executing a financing agreement between said insured entity and a premium financier wherein said insured entity agrees to make periodic payments and said premium financier agrees to fund said insurance contract;
providing a contract funding host server in communication with an accounts database;
establishing an account entry in said contract funding database by said contract funding host server, wherein said account entry comprises:
information identifying an insurance company associated with said insurance contract,
a premium payment amount corresponding to said insurance contract,
a start date,
a remittance date subsequent to said effective date, and
information identifying a payment account to which payment of said premium payment is to be made;
calculating by said contract funding host server an accumulated interest amount on said premium payment amount for a period from said start date to said remittance date; and
making a payment from said premium financier to said insurance company of said accumulated interest.

15. The method of claim 14, wherein said insurance company is a company type selected from the group of company types consisting of: a retail insurance agency, a general insurance agency, and an insurance carrier.

16. The method of claim 14, wherein said establishing an account entry in said contract funding database comprises:
accessing said contract funding host server through a computer network over a secure connection between a data entry device and said contract funding host server; and
entering at least one portion of information in said account entry through said data entry device.

17. The method of claim 16, wherein said establishing an account entry in said contract funding database comprises modifying information in said account entry using said data entry device.

18. The method of claim 16, wherein said establishing an account entry in said contract funding database comprises creating a new account entry using said data entry device.

19. The method of claim 14, further comprising:
determining when said effective date has been reached; and
crediting said premium payment amount to said account entry by said contract funding host server.

20. The method of claim 14, wherein said calculating by said contract funding host server an accumulated interest amount comprises:
calculating an interest earned on said premium payment amount during said period by said contract funding host server when an end of a compound interest period has been reached; and
crediting said interest earned to said accumulated interest of said account entry by said contract funding host server.

21. The method of claim 20 wherein said compound interest period is selected from the group of time intervals consisting of: a day, a week, and said period from said start date to said remittance date.

22. The method of claim 14 further comprising initiating from said contract funding host server an electronic transfer of funds in an amount equal to said premium payment amount and to be transferred from an account of said premium financier to said payment account on said remittance date, wherein said initiating from said contract funding host server an electronic transfer of funds comprises debiting said premium payment amount from said account entry by said contract funding host server when said remittance date has been reached.

23. The method of claim 14, further comprising:
creating a statement for said account entry by said contract funding host server when a statement date has been reached; and
communicating said statement to the insurance company associated with said account.

24. The method of claim 14, wherein said making a payment from said premium financier to said insurance company of said accumulated interest comprises paying a portion of said accumulated interest to the insurance company associated with said account when an interest payment date has been reached.

25. The method of claim 14, wherein:
said account entry further comprises:
information identifying an insurance agency, and
an agency remittance date associated with said insurance agency;
wherein calculating by said contract funding host server an accumulated interest amount comprises:
calculating a first interest amount for a period from said start date to said agency remittance date, and
calculating a second interest amount for a period from said agency remittance date to said remittance date; and
wherein said making a payment from said premium financier to said insurance company of said accumulated interest comprises:
paying said first interest amount to said insurance agency, and
paying said second interest amount to said insurance company.

26. The method of claim 14, wherein said making a payment from said premium financier to said insurance company of said accumulated interest comprises initiating from said contract funding server an electronic funds transfer from an account associated with said premium financier to an account associated with said insurance company.

27. The method of claim 14, further comprising a plurality of account entries stored in said contracts funding database, each account entry associated with a different one of a plurality of insurance companies.

28. The method of claim 14, wherein said start date is selected from the group of dates consisting of: a date equal to said effective date and a date before said effective date.

29. The method of claim 14, wherein said calculating by said contract funding host server an accumulated interest amount comprises calculating an accumulated interest amount on a plurality of premium payment amounts corresponding to a plurality of insurance contracts related to said insurance company.
